(19) United States
(12) Patent Application Publication
(10) Pub. No.: US 2010/0138811 A1
(43) Pub. Date: Jun. 3, 2010

(54) Dynamic Performance Profiling

(75) Inventors: Satya Jayaraman, Hyderabad (IN); Sachin Abhyankar, San Diego, CA (US); Akex Kwang-Ho Jong, San Diego, CA (US); Richard Alfred Higgins, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/326,183

(22) Filed: Dec. 2, 2008

(51) Int. Cl. G06F 11/36

(52) U.S. Cl. 717/125

(57) ABSTRACT

A dynamic performance profiler is operable to receive, in substantially real-time, raw performance data from a testing platform. A software-based image is executing on a target hardware platform (e.g., either simulated or actual) on the testing platform, and the testing platform monitors such execution to generate corresponding raw performance data, which is communicated, in substantially real-time, as it is generated during execution of the software-based image to a dynamic profiler. The dynamic profiler may be configured to archive select portions of the received raw performance data to data storage. As the raw performance data is received, the dynamic profiler analyzes the data to determine whether the performance of the software-based image on the target hardware platform violates a predefined performance constraint. When the performance constraint is violated, the dynamic profiler archives a portion of the received raw performance.

### TECHNICAL FIELD

The following description relates generally to performance profiling of a software image on a target hardware platform, and more particularly to performance profiling systems and methods in which a profiler receives performance data from a testing platform in substantially real-time (i.e., as the performance data is generated by the testing platform).

### BACKGROUND

Testing and analysis are important for evaluating the performance of individual components of computer systems, such as software, firmware, and/or hardware. For instance, during development of a software, hardware, or firmware component, some level of testing and debugging is conventionally performed on that individual component in an effort to evaluate whether the component is functioning properly. As an example, software applications under development are commonly debugged to identify errors in the source code and/or to otherwise evaluate whether the software application performs its operations properly, i.e. without the software application producing an incorrect result, locking up (e.g., getting into an undesired infinite loop), producing an undesired output (e.g., failing to produce an appropriate graphical or other information output arranged as desired for the software application), etc. As another example, hardware components, such as processors (e.g., digital signaling processors) and/or other functional hardware devices, are often tested to evaluate whether the hardware performs its operations properly, such as by evaluating whether the hardware produces a correct output for a given input, etc.

Beyond testing of individual components of a system, such as individual software programs and individual hardware components, in isolation, in some instances the performance of certain software or firmware on a target hardware platform may be evaluated. The “target hardware platform” refers to a hardware platform on which the software or firmware is intended to be implemented (e.g., for a given product deployment). Such target hardware platform may be a given integrated circuit (IC), such as a processor, memory, etc., multiple ICs (e.g., coupled on a system board), or a larger computer system, such as a personal computer (PC), laptop, personal digital assistant (PDA), cellular telephone, etc. It may be desirable, for instance, to evaluate how well certain software programs perform on a target hardware system, not only to ensure that both the software program and the target hardware system function properly but also to evaluate the efficiency of their operations. Such factors as memory (e.g., cache) utilization, central processing unit (CPU) utilization, input/output (I/O) utilization, and/or other utilization factors may be evaluated to determine the efficiency of the software programs on the target hardware platform. From this evaluation, a developer may modify the software programs in an effort to optimize their performance (e.g., to improve memory, CPU, and/or I/O utilization) on the target hardware platform. For instance, even though the software program and target hardware platform may each function properly (e.g., produce correct results), the software program may be modified in some instances in an effort to improve its efficiency of operations on the target hardware platform.

Commonly, a program known as a “profiler” is used for evaluating the performance of a software program on a target hardware platform or in a simulation environment. Various profilers are known in the art, such as those commercially known as Qprof, Gprof, Sprof, Cprof, Oprofile, and Prospect, as examples. Profilers may evaluate the performance of a software program executing on a target hardware platform or executing on a simulation of the target hardware platform. Profilers are conventionally used to evaluate the performance efficiency of operations of a software program executing on a target hardware platform in an effort to identify areas in which the software program may be modified in order to improve its efficiency of operation on the target hardware platform. In other words, rather than evaluating the software program and/or target hardware platform for operational accuracy (e.g., to detect bugs), the profiler is conventionally used for evaluating performance of a software program on a target hardware platform. In certain situations, performance issues may cause the system to behave incorrectly. For example, if one application does not get enough execution time due to another (potentially higher priority) application taking longer than it is supposed to, then this may cause incorrect output to get generated. Optimization of the latter application would be a “bug fix” from the system point of view.

Detecting “bugs” caused by performance issues is not an easy task because of at least two reasons. First, all performance issues may not cause bugs. For example, some applications may be sub-optimal, but their increased execution time may not interfere with the meeting of real-time deadlines of other tasks (i.e., the increased execution time is at a time when the other tasks' work is not time critical). And, in some instances a performance issue may not cause “bugs” at all times during the program. For instance, the increased execution time due to sub-optimal implementation, for example, should occur at a time when other tasks are doing time critical work

The performance is evaluated in an effort to optimize the efficiency of operations of the software program on the target hardware platform in order to improve the overall performance of the resulting deployed system. For instance, such profiling may permit a user of the profiler to evaluate where the software program spent its time and which functions called which other functions while it was executing.

In addition, information regarding how the target hardware handled the various functions, including its cache utilization efficiency (e.g., cache hit/miss ratio, etc.) and CPU utilization efficiency (e.g., number of “wait” cycles, etc.), as examples, may be evaluated by the profiler. The evaluation provides the user with information about the efficiency of the performance of the software program's functions on the target hardware platform. Such operational parameters as cache utilization efficiency and CPU utilization efficiency vary depending on the specific target hardware platform's architecture (e.g., its cache size and/or cache management techniques, etc.). Thus, the profiler evaluation is informative as to how well the software program will perform on the particular target hardware platform. The user may use the profiler information to modify the software program in certain ways to improve its cache utilization efficiency, CPU utilization efficiency, and/or other operational efficiencies on the target hardware platform.

FIG. 1 is an exemplary block diagram of a system 100 that illustrates a conventional manner in which a profiler is typically employed. As shown, a testing platform 110 is provided on which a target hardware platform 101 resides. The testing platform 110 may be any suitable testing platform that is operable to evaluate operation of a software-based image 102 on a target hardware platform 101 and produce performance data about such execution as discussed further herein. The testing platform 110 may be a computer-based system having sufficient communication connections to portions of the target hardware 101 and/or the image 102 to observe the operations for determining the corresponding performance data.

A software-based “image” 102 executes on the target hardware 101, and the testing platform 110 monitors its execution to generate performance data that is archived to a data storage 103 (e.g., hard disk, optical disk, magnetic disk, or other suitable data storage to which digital data can be written and read). The software-based image 102 may be any software application, firmware, operating system, and/or other product that is software based. The performance data generated and archived in the data storage 103 may include detailed information pertaining to the operational efficiency of the software image 102 on the target hardware platform 101. The information may detail the functions being executed at various times and the corresponding number of wait cycles of the target hardware platform's CPU, the hit/miss ratio in the target hardware platform's cache, and other operational efficiency details.

The performance data generated by the testing platform and archived to the data storage 103 may be referred to as raw performance data. The raw performance data conventionally details information about function(s) performed over clock cycles of a reference clock of the target hardware platform 101, as well as corresponding information about utilization of CPU, cache, and/or other resources of the target hardware platform 101 over the clock cycles. The raw data is conventionally in some compressed format. As an example, the compression is commonly one of two types: 1) reduced information that can extrapolated to reconstruct the entire information, or 2) compression like zipping, etc.

As an illustrative simple example, a portion of the raw performance data generated by the testing platform 110 may be similar to that provided in Table 1 below:

TABLE 1

| Function | Clock Cycle |
|---|---|
| MMDM Start | 5 |
| Wait | 10 |
| Process P1 | 12 |
| MMDM End | 12 |

In the above example, the raw performance data generated by the testing platform 110 notes that a memory data management operation (MMDM) started on the target hardware platform 101 in clock cycle 5, and such MMDM operation ended in clock cycle 12. Also, the raw performance data generated by the testing platform 110 notes that the target hardware platform's CPU entered a wait state in clock cycle 10, and then began processing a process “P1” (of image 102) in clock cycle 12. It should be recognized by those of ordinary skill in the art that Table 1 provides a simplistic representation of the raw performance data for ease of discussion, and conventionally much more information may be contained in the raw performance data generated by the testing platform 110.

A profiler 120 may then be employed to analyze (104) the raw performance data that is archived to the data storage 103 in order to evaluate the operational performance of the software image 102 on the target hardware platform 101. As discussed above, the profiler 120 may permit a user to evaluate execution of the software image 102 (e.g., where the software image spent its time and which functions called which other functions, etc.), as well as how the target hardware platform 101 handled the various functions of the software image 102, including its cache utilization efficiency (e.g., cache hit/miss ratio, etc.) and CPU utilization efficiency (e.g., number of “wait” cycles, etc.), as examples. That is, the profiler 120 analyzes the raw performance data generated by the testing platform 110 and may present that raw performance data in a user-friendly manner and/or may derive other information from the raw performance data to aid the user in evaluating the operational efficiency of the image 102 on the target hardware platform 101. The profiler 120 may present the information in a graphical and/or textual manner on a display to enable the user to easily evaluate the operational efficiency of the execution of the image 102 on the target hardware platform 101 over the course of the testing performed. The user may choose to use the performance information presented by the profiler 120 to modify the software image 102 in certain ways to improve the cache utilization efficiency, CPU utilization efficiency, and/or other operational efficiencies on the target hardware platform 101.

Conventionally, profiling a software image 102 on a target hardware platform 101 in the manner illustrated in FIG. 1 results in a large amount of raw performance data being generated and archived in the data storage 103 for later use in the profiler 120's analysis 104. For example, to profile execution of a 30-second video clip (of a software image 102) on the target hardware 101, the testing platform 110 may run for multiple days and generate a massive amount of raw performance data (e.g., approximately 10 terabytes of data). Thus, a large-capacity data storage 103 is needed for archiving the raw performance data for later use by the profiler 120 in performing the analysis 104. Also, loading and analyzing such large amounts of data is a non-trivial task.

In some instances, certain steps may be taken in the testing platform 110 in an effort to reduce the amount of raw performance data generated by the testing platform, such as by focusing the testing on only a particular part of the software image 102 or configuring the testing platform 110 to only capture performance data pertaining to execution of a particular portion of the software image 102. The profiler 120 is then employed to analyze 104 performance of the particular portion of the software image 102 by evaluating the corresponding raw performance data archived to the data storage 103 by the testing platform 110 during the testing. Of course, by restricting the testing at the testing platform 110 in this manner requires the user to identify the portion of the execution of the image 102 on which the testing should be focused, and one risks potentially overlooking performance problems with other portions of the software image 102. For instance, when configuring the testing platform 110 the user may not possess sufficient information to make an intelligent decision regarding how best to restrict testing of the image 102 because it is conventionally during the later profiling process in which the user discovers areas of operational inefficiencies of the image 102 on the target hardware platform 101. Accordingly, there exists a need in the art for an improved profiler, particularly a profiler that does not require storage of all raw performance data generated but that enables full evaluation of performance for operational efficiency and/or debugging analysis.

### SUMMARY

Embodiments of the present invention are directed generally to systems and methods for dynamic performance profiling. According to one embodiment, a method for performing system profiling is disclosed, wherein a profiler receives performance constraint data from a user. The performance constraint data defines boundary conditions for an event. The profiler receives, in substantially real-time, raw performance data from a testing platform on which an execution entity to be profiled is executing. The profiler analyzes the received raw performance data to determine when the execution entity violates a performance constraint defined by the performance constraint data, and only a portion of the received raw performance data is stored, wherein the portion corresponds to a time period of execution of the execution entity that overlaps when a determined performance constraint violation occurred.

According to another embodiment, a system for profiling performance of a software-based image on a target hardware platform is provided. As used herein (except where expressly indicated otherwise), “target hardware platform” may refer to either an actual implementation of the target hardware platform or a simulation thereof. The system has a testing platform for generating raw performance data for a software-based image executing on a target hardware platform. A dynamic profiler is communicatively coupled to the testing platform for receiving the raw performance data in substantially real-time as it is generated by the testing platform. The dynamic profiler is operable to determine, based at least in part on analysis of the received raw performance data, a portion of the received raw performance data to archives The system further includes data storage for archiving the determined portion of the received raw performance data.

According to another embodiment, a computer program product includes a computer-readable medium to which computer-executable software code is stored. The code includes code for causing a computer to receive raw performance data in substantially real-time when generated by a testing platform on which a software-based image is executing on a target hardware platform. The code further includes code for causing the computer to determine whether the received raw performance data indicates violation of a pre-defined performance constraint. And, the code further includes code for causing the computer to, responsive to determining that the received raw performance data indicates violation of a pre-defined performance constraint, archive a corresponding portion of the received raw performance data, wherein the corresponding portion encompasses the received raw performance data that indicated violation of the performance constraint.

The foregoing has outlined rather broadly the features and technical advantages of the present invention in order that the detailed description that follows may be better understood. Additional features and advantages will be described hereinafter which form the subject of the claims of the invention. It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the teachings of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following description taken in conjunction with the accompanying drawings.

FIG. 1 is an exemplary block diagram of a system that illustrates a conventional manner in which a performance profiler is employed.

FIG. 2 is an exemplary block diagram of a system that illustrates application of a dynamic performance profiler.

FIG. 3 is an exemplary block diagram that illustrates application of a dynamic performance profiler in which a defined performance constraint is employed for determining raw performance data to be archived to data storage.

FIG. 4 is a block diagram of an exemplary implementation of a dynamic profiler for profiling performance of firmware on a digital signal processor (DSP).;

FIG. 5 is a screen shot showing a portion of an exemplary user interface presented to a user by a dynamic profiler, which enables a user to choose to configure the dynamic profiler to operate in either post-mortem mode, real-time mode, or constraint violation mode.

FIG. 6 is a screen shot showing a dialog box presented to a display by the dynamic profiler in response to a user selecting to configure the dynamic profiler to operate in real-time mode.

FIG. 7 is a screen shot showing an exemplary constraint window that may be presented by the dynamic profiler to allow a user to specify time limits between arbitrary system events and list all violations of the limits.

FIG. 8 is a screen shot showing an exemplary interface that may be presented by the dynamic profiler to allow a user to view the constraint violations for a given constraint.

FIG. 9 is a screen shot showing an exemplary constraint violations window that may be presented by the dynamic profiler to allow a user to view the original performance constraints and constraint violations generated by the constraint violation mode.

FIG. 10 is a screen shot showing an exemplary execution profile window that may be presented by the dynamic profiler.

FIGS. 11A-11C are screen shots showing an exemplary cache profile window that may be presented by the dynamic profiler.

FIG. 12 is a screen shot showing an exemplary cache address history window that may be presented by the dynamic profiler.

FIG. 13 is a screen shot showing an exemplary cache line history window that may be presented by the dynamic profiler.

FIG. 14 is a screen shot showing an exemplary cache histogram window that may be presented by the dynamic profiler.

FIGS. 15A-15B are screen shots showing an exemplary cache use by function window that may be presented by the dynamic profiler.

FIGS. 16A-16B are screen shots showing an exemplary cache summary window that may be presented by the dynamic profiler.

FIG. 17A is a screen shot showing an exemplary menu for selecting variable use by cache block that may be presented by the dynamic profiler.

FIG. 17B is a screen shot showing an exemplary variable usage per cache block window that may be presented by the dynamic profiler.

FIG. 18 is an operational flow diagram.

FIG. 19 is a block diagram showing an exemplary computer system on which embodiments of a dynamic profiler may be implemented.

### DETAILED DESCRIPTION

Embodiments of the present invention are directed generally to systems and methods for dynamic performance profiling. As discussed further below, a dynamic performance profiler is disclosed that is operable to receive, in substantially real-time, raw performance data from a testing platform. Thus, as a testing platform on which a software-based image is executing on a target hardware platform (e.g., either simulated or actual), the testing platform generates raw performance data that is communicated, in substantially real-time, as it is generated during execution of the software-based image to a dynamic profiler. The “testing platform”, as used herein, refers generally to any logic for observing performance of the target hardware platform and generating performance data about the execution of the software-based image on the target hardware platform. The testing platform may be implemented in any desired manner (e.g., either as separate logic with which the target hardware platform is coupled, or in whole or in part as logic that is integrated within the target hardware platform).

The dynamic profiler may be configured to archive select portions of the received raw performance data to data storage. For instance, in certain embodiments, the dynamic profiler may archive a moving window of the last “X” amount of raw performance data received. In certain embodiments, the amount “X” may be user-configurable, such as by a user specifying to archive raw performance data generated for the last “X” number of clock cycles of a reference clock signal of the target hardware platform under testing.

In certain embodiments, the dynamic profiler supports a constraint-violation mode, wherein a user may define one or more performance constraints. As the raw performance data is received, the dynamic profiler analyzes the data to determine whether it indicates that the performance of the software-based image on the target hardware platform violates a defined performance constraint, and upon a performance constraint being determined as being violated, the dynamic profiler may archive a portion of the received raw performance data (which encompasses the raw performance data indicating the violation of the performance constraint) to data storage.

Thus, embodiments of the dynamic profiler enable a user to configure the dynamic profiler to manage an amount of raw performance data that is archived. Accordingly, unrestricted testing on the testing platform may be performed, and the dynamic profiler may analyze the generated raw performance data, received in substantially real-time, to determine, based on performance of the software-based image on the target hardware platform under testing, appropriate portions of the generated raw performance data to archive to data storage.

Further, in certain embodiments, because the dynamic profiler receives the generated raw performance data in substantially real-time, it may also be used for performing certain debugging operations. Thus, in addition to its ability to provide performance analysis (e.g., for performance optimization evaluation), in certain embodiments the dynamic profiler may further be employed for debugging the software-based image. As an example, in certain situations, performance issues may cause the system to behave incorrectly. For instance, if one application does not get enough execution time due to another (potentially higher priority) application taking longer than it is supposed to, then this may cause incorrect output to be generated. Optimization of the latter application would be a “bug fix” from the system point of view. Thus, the dynamic profiler may be utilized to perform this, as well as other types of debugging based on the performance data that it receives in substantially real-time.

In some embodiments, a certain level of debugging may be performed by the dynamic profiler, for instance, to identify whether specific user-defined constraints are violated. The dynamic profiler may be configured to archive performance data pertaining to any such constraint violation that is detected, thereby enabling the user to evaluate data relating specifically to such a constraint violation (or “bug”).

Certain embodiments provide superior debugging to that afforded by conventional profilers. As an example, in certain embodiments various information pertaining to CPU utilization, cache utilization (e.g., cache utilization by process, by variable, etc.) during the testing may be presented to the user, used as predefined constraint conditions, and/or otherwise used for debugging, as discussed further herein. The debugging capabilities of certain embodiments of the dynamic performance profiler are advantageous because embodiments of the dynamic performance profiler provides a constraint violation mode of operation (as discussed further herein). As mentioned above, detecting “bugs” caused by performance issues is not an easy task. Use of constraint violation mode provided by embodiments of the dynamic performance profiler eases such detection of bugs caused by performance issues. That is, the constraint violation mode provides improved debugging capabilities because it enables detection of violation of certain predefined constraints on the performance of the image under test, as discussed further herein, which may aid in discovery of performance-related bugs.

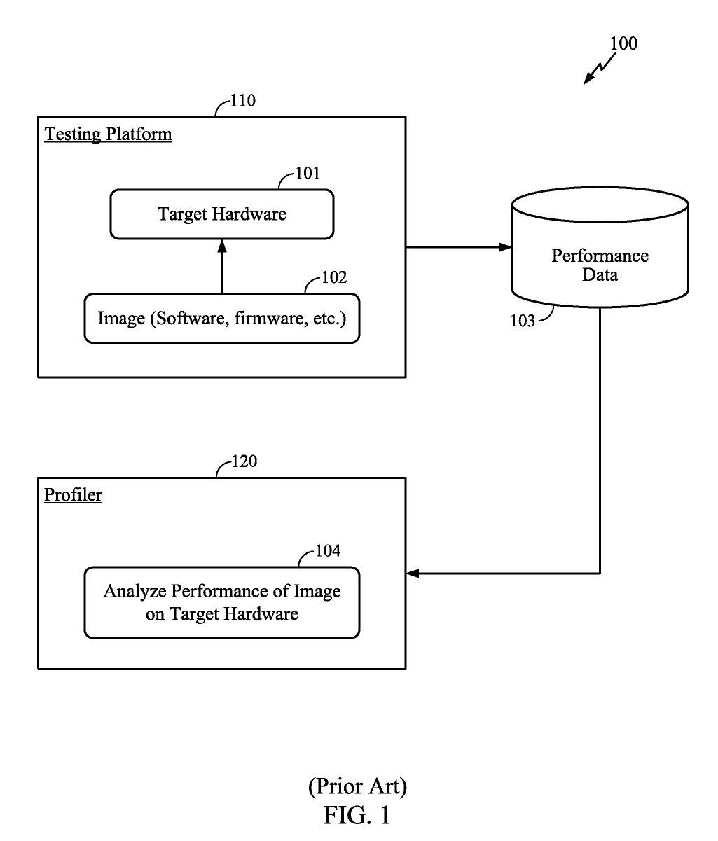

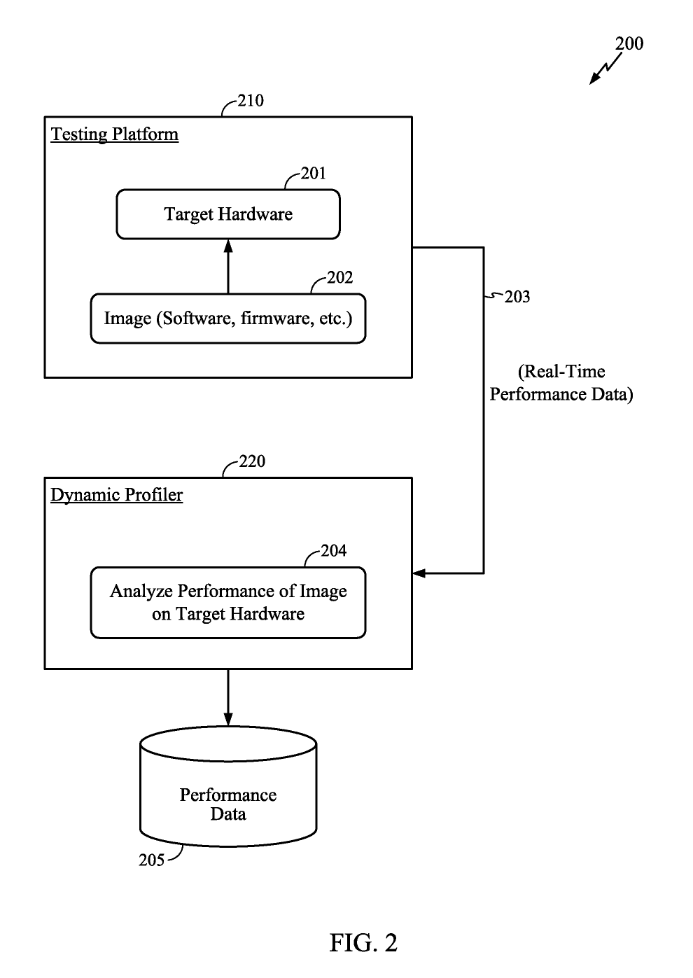

FIG. 2 is an exemplary block diagram of a system 200 that illustrates application of a dynamic performance profiler 220 in accordance with one embodiment. As in the conventional system 100 of FIG. 1, a testing platform 210 is provided on which a target hardware platform 201 resides. The testing platform 210 may be any computer-based logic (or “platform”) for observing performance of the target hardware platform 201 and generating data about such performance. The testing platform 210 may, in some instances, be separate from the target hardware platform 201 (e.g., and communicatively coupled to the target hardware platform 201 for observing its operations), or in other instances, all or a portion of the testing platform 210 may be integrated within the target hardware platform 201 (e.g., such that the target hardware platform 201 may itself include logic for observing its performance and outputting its performance data).

The target hardware platform 201 may be an actual implementation of the target hardware platform (e.g., an actual hardware implementation) or, in some instances, the target hardware platform 201 is simulated (e.g., by a program that simulates the operation of the target hardware platform). A software-based “image” 202 executes on the target hardware 201, and the testing platform 21 monitors its execution to generate raw performance data.

However, in this embodiment, as such raw performance data is generated by the testing platform 210, it is communicated in substantially real-time (as real-time performance data 203) to the dynamic profiler 220. Thus, rather than being archived to the data storage 103 for later retrieval by the profiler 120 (as in the conventional implementation of FIG. 1), the exemplary embodiment of FIG. 2 communicates the real-time performance data 203 from the test platform 210 to the dynamic profiler 220, thus alleviating the conventional requirement of first archiving the raw performance data to a data storage 103.

Of course, some data storage may occur for facilitating communication of the real-time performance data 203 from the testing platform 210 to the dynamic profiler 220. For instance, such real-time performance data 203 may be buffered or otherwise temporarily stored from a period when it is generated by the testing platform 210 until a communication agent can communicate it to the dynamic profiler 220. It should be recognized, however, that in accordance with certain embodiments portions of the real-time performance data 203 are communicated from the testing platform 210 to the dynamic profiler 220 during ongoing testing. That is, rather than waiting for the full testing by the testing platform 210 to complete before communicating the generated raw performance data to the dynamic profiler 220 (thus requiring the full raw performance data to be first archived, as in FIG. 1), at least portions of the real-time performance data 203 are communicated from the testing platform 210 to the dynamic profiler 220 during the testing. Again, such real-time performance data 203 is preferably communicated from the testing platform 210 to the dynamic profiler 220 substantially as such data is generated by the testing platform 210 (except for temporary storage that may be performed for managing such communication). In certain embodiments, the real-time performance data 203 is streamed (i.e., communicated in a streaming fashion) from the testing platform 210 to the dynamic profiler 220.

The software image 202 may be any software application, firmware, operating system, and/or other component that is software based. The real-time performance data 203 generated by the testing platform 210 may be detailed information pertaining to the operational efficiency of the software image 202 on the target hardware platform 201. The information may detail the functions being executed at various times and the corresponding number of wait cycles of the target hardware platform's CPU, corresponding cache hits and misses for the functions in the target hardware platform's cache, and other operational efficiency details. Such real-time performance data 203 may correspond to raw performance data commonly generated by a testing platform 210 (such as the commercially available testing platforms identified above), but is supplied in substantially real-time from the testing platform 210 to the dynamic profiler 220, rather than first being archived to a data storage 103.

The dynamic profiler 220 receives the real-time performance data 203 and analyzes (block 204) the received performance data to evaluate the performance of the software image 202 on the target hardware platform 201. Such dynamic profiler 220 may evaluate execution of the software image 202 (e.g., where the software image spent its time and which functions called which other functions, etc.), as well as how the target hardware platform 201 handled the various functions of the software image 202, including its cache utilization efficiency (e.g., cache hit/miss ratio, etc.) and CPU utilization efficiency (e.g., number of “wait” cycles, etc.), as examples. Thus, the dynamic profiler 220 may provide the user with information about the efficiency of the performance of the software image 202 on the target hardware platform 201. The user may choose to use the profiler information to modify the software image 202 in certain ways to improve its cache utilization efficiency, CPU utilization efficiency, and/or other operational efficiencies on the target hardware platform 201. As with conventional dynamic profilers, the dynamic profiler 220 may be implemented as computer-executable software code executing on a computer system, such as a personal computer (PC), laptop, workstation, mainframe, server, or other processor-based system.

The dynamic profiler 220 may choose to archive certain portions of the received performance data to a data storage 205. For instance, based on its analysis in block 204, the dynamic profiler 220 may identify performance data that pertains to a potential performance problem that is of interest to a user, and the dynamic profiler 220 may archive only the identified performance data that pertains to the potential performance problem (rather than archiving all of the received performance data). In this way, the amount of performance data that is archived to the data storage 205 may be greatly reduced from the full amount of raw performance data generated by the testing platform 210. Further, as discussed below, the decision of what performance data to archive can be made based on analysis in block 204 of operational efficiency of the software image 202 on the target hardware platform 201, rather than requiring a user to restrict testing on the testing platform 210. Thus, according to this embodiment, the dynamic profiler 220 permits full testing of the software image 202 on the target hardware platform 201 to be conducted by the testing platform 210, and the dynamic profiler 220 is operable to receive and analyze the full raw performance data generated by the testing platform 210 to identify operational inefficiencies. Also, the dynamic profiler 220 can archive only portions of the raw performance data that are obtained for a window(s) of time (e.g., clock cycles) that encompass those identified operational inefficiencies.

As discussed further below, in certain embodiments, the dynamic profiler 220 allows a user to define certain performance constraints, and when determined by the analysis in block 204 that the performance of the software image 202 on the target hardware platform 201 violates any of the defined performance constraints, the dynamic profiler 220 archives corresponding performance data pertaining to the performance constraint violation to the data storage 205. For instance, a user may define that upon a given performance constraint being determined by the analysis in block 204 as being violated, the dynamic profiler 220 is to archive performance data received for some user-defined window of time that encompasses the constraint violation. For example, a user may define that upon a given performance constraint being determined by the analysis in block 204 as being violated, the dynamic profiler 220 is to archive performance data received for some user-defined number (e.g., one million) of clock cycles leading up to the constraint violation as well as some user-defined number (e.g., one million) of clock cycles following the constraint violation. This feature allows unrestricted testing and profile analysis of the software image 202 on the target hardware platform 201, while restricting the archiving of raw performance data to only that raw performance data that is related to a portion of the testing in which some user-defined performance constraint is violated. Various illustrative examples of performance constraints that may be employed are provided further herein.

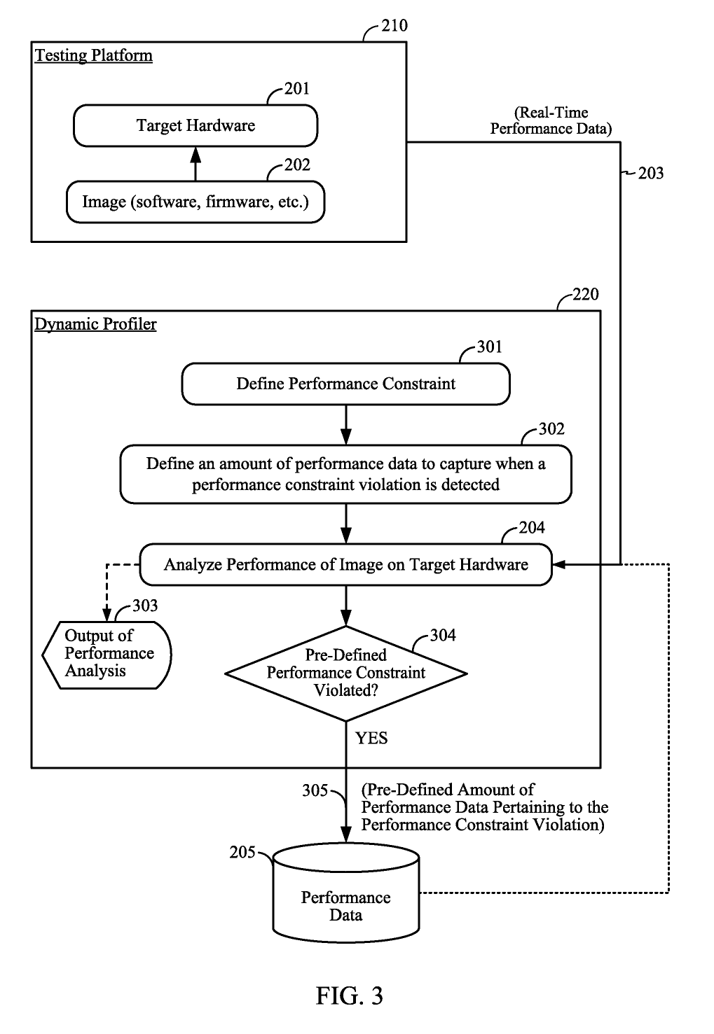

FIG. 3 is an exemplary block diagram illustrating application of a dynamic performance profiler 220 according to one embodiment in which a defined performance constraint is employed for determining raw performance data to be archived to the data storage 205. Various elements shown in the example of FIG. 3 correspond to elements described above for FIG. 2 and are thus numbered/labeled the same as in FIG. 2. The additional elements 301-305 introduced in the exemplary embodiment of FIG. 3 are described further below.

In the exemplary embodiment of FIG. 3, the dynamic profiler 220 allows a user to define certain performance constraints 301. For instance, as discussed further herein, the dynamic profiler 220 may provide a user interface with which a user may interact to define performance constraints. For example, in a real time system, it would be desirable to know when processing of a certain event occurs more than a particular number of cycles after detection of the event.

Also, the dynamic profiler 220 allows a user to define, in block 302, an amount of performance data to archive when a given performance constraint violation is detected. For instance, a user may define that upon a given performance constraint being determined by the analysis in block 204 as being violated, the dynamic profiler 220 is to archive performance data received for some user-defined window of time that encompasses the constraint violation. For example, a user may define that upon a given performance constraint being determined by the analysis in block 204 as being violated, the dynamic profiler 220 is to archive performance data received for some user-defined number (e.g., one million) of clock cycles leading up to the constraint violation as well as some user-defined number (e.g., one million) of clock cycles following the constraint violation. Again, as discussed further herein, the dynamic profiler 220 may provide a user interface with which a user may interact to define the amount of performance data to archive for a given performance constraint violation.

In block 204, the dynamic profiler 220 receives the real-time performance data 203 and analyzes such raw performance data. As part of the analysis in block 204, the dynamic profiler 220 determines, in block 304, whether a predefined performance constraint (defined in block 301) is violated. When such a violation is detected, then the predefined amount of performance data (defined in block 305) pertaining to the performance constraint violation detected is archived by the dynamic profiler 220 to the storage 205. The dynamic profiler 220 may be used thereafter by a user to analyze (in block 204) the archived performance data. For instance, the dynamic profiler 220 may output, in block 303, information detailing a performance analysis for such archived performance data. For example, in certain embodiments a graphical and/or textual output to a display may be generated to inform the user about the performance data observed during testing for portions of the testing that violated the user's pre-defined performance constraints. Illustrative examples of such output that may be presented in certain embodiments are provided further herein.

Various testing platforms and profilers are known in the art for testing and evaluating performance of software images on a target hardware platform, which may be adapted for enabling communication of performance data from the testing platform to the profiler in substantially real-time during testing in accordance with the embodiments disclosed herein.

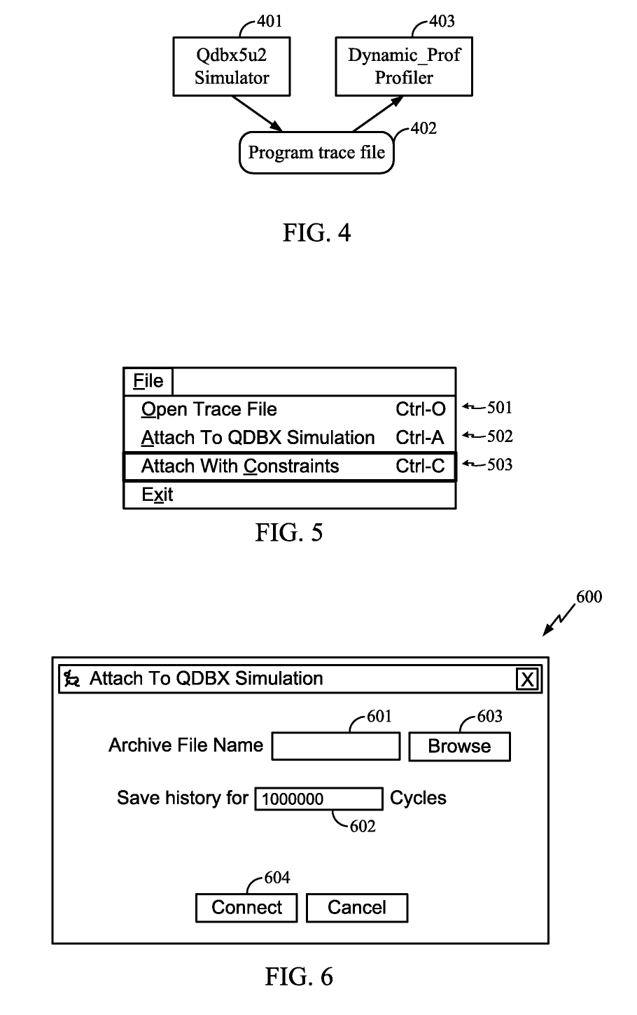

In one implementation, the testing platform 210 includes such a DSP simulator as the target hardware platform 201, which is operable to generate raw performance data for the execution of a software image 202 on the DSP. The tools further include a profiler, which will be referred to as Dynamic_Prof. FIG. 4 is a block diagram showing such an exemplary implementation in which the QDBX simulator 401 executes a software image (e.g., software image 202 of FIGS. 2-3) and generates corresponding raw performance data. As discussed above, the raw performance data is conventionally stored to data storage, e.g., as a program trace file 402, which can be retrieved for analysis by the Dynamic_Prof 403. As illustrated by the dashed arrow in FIG. 4, in certain embodiments, the generated raw performance data may be communicated in substantially real-time from the QDBX simulator 401 to the Dynamic_Prof 403, rather than requiring the generated raw performance data for an entire testing session to be first archived.

Thus, as discussed further herein, the Dynamic_Prof 403 may be implemented as a dynamic profiler (such as the dynamic profiler 220 discussed above). In certain embodiments, the profiler can operate either in post-mortem mode (using a program trace file 402 generated by a completed simulation performed by the QDBX simulator 401) or real-time mode (using live data generated by a running simulation of the QDBX simulator 401). In addition, in the real-time mode execution (or “performance”) constraints are supported, which may be used to limit the amount of profile data archived for a simulation.

In certain embodiments, the dynamic profiler supports three modes of operation: 1) post-mortem mode, 2) real-time mode, and 3) constraint violation mode. In the post-mortem mode, the dynamic profiler uses an archived trace file (containing raw performance data) generated by a completed testing session on the testing platform (e.g., a completed simulation) for performing its analysis (e.g., the analysis of block 204 of FIG. 2). Thus, such post-mortem mode of operation employs the conventional profiling technique discussed generally above with FIG. 1. According to one embodiment, the post-mortem mode supports complete system traces which can be accessed repeatedly without having to re-run the testing/simulation on the testing platform, and can display any point in the testing time. However, long testing/simulations on the testing platform can generate arbitrarily large trace files which either load too slowly or (if they exceed system memory) cannot be loaded.

In the real-time mode, the dynamic profiler uses raw performance data generated by a running testing platform (e.g., a running QDBX simulation), and the dynamic profiler may log at least portions of the execution history and/or information derived from the received raw performance data in a trace file. In one embodiment, the real-time mode supports arbitrarily long testing/simulations, but can display (and save) only partial system traces (i.e., raw performance data generated by the testing platform). In certain implementations, partial traces are saved in “zip” format to minimize the trace file size, and the maximum trace file length is user-specifiable. Partial trace files are accessible in the dynamic profiler via the conventional post-mortem mode.

The constraint-violation mode is really a sub-set of the real-time mode. In other words, it works like the real-time mode, but the dynamic profiler is configured to log only performance data for specified performance constraint violations detected in the profiler's analysis of the received raw performance data. Such constraint violation mode may be used to analyze long testing/simulations for limiting the amount of raw performance data that is archive to instances where the raw performance data violates a set of predefined constraints. The resulting raw performance data (or “trace file”) that is archived can be later accessed using the post-mortem mode of the profiler.

FIG. 5 is a screenshot illustrating a portion of an exemplary user interface presented to a user by the profiler 403 according to one embodiment, which enables a user to choose to attach the profiler 403 to the QDBX simulator 401 for receipt of raw performance data generated by the QDBX simulator 401 in substantially real-time. In this exemplary interface, an option 501 to Open Trace File can be selected by a user (e.g., by clicking a pointing device, such as a mouse on the option), which enables a user to choose to open a program trace file such as program trace file 402 that has been generated and archived from prior testing, as in conventional profiling techniques. In other words, the option 501 enables the user to select to run the profiler in the above-mentioned post-mortem mode.

Alternatively, an option 502 to Attach to QDBX Simulation can be selected by a user (e.g., by clicking a pointing device, such as a mouse on the option), which results in the profiler 403 setting up a communication channel with the QDBX simulator 401 for receiving generated raw performance data in substantially real-time (e.g., via the dashed line shown in FIG. 4). In other words, the option 502 enables the user to select to run the profiler in the above-mentioned real-time mode.

As another alternative, an option 503 to Attach With Constraints can be selected by a user (e.g., by clicking a pointing device, such as a mouse on the option), which not only results in the profiler 403 setting up a communication channel with the QDBX simulator 401 for receiving generated raw performance data in substantially real-time (e.g., via the dashed line shown in FIG. 4) but also allows performance constraints to be defined (as discussed above in block 301 of FIG. 3) for use by the profiler 403 in identifying portions of the received raw performance data to be archived to data storage. In other words, the option 503 enables the user to select to run the profiler in the above-mentioned constraint-violation mode.

The option 502 may be selected by a user to place the profiler into a real-time mode for use in analyzing a running test/simulation on the testing platform, such as a running simulation on the QDBX simulator 401. For instance, for the exemplary Dynamic_Prof example of FIG. 4, in the real-time mode the Dynamic_Prof profiler 403 connects to a running simulation (on the QDBX simulator 401) using a User Datagram Protocol (UDP) socket interface. The Dynamic_Prof profiler 403 may output to a display user-interface window(s) (as in block 303 of FIG. 3), which displays information that is updated continuously based on trace information (or “raw performance data”) generated by the QDBX simulator 401. The trace information may be saved by the Dynamic_Prof profiler 403 in a trace file for later analysis in post-mortem mode.

In one embodiment, in response to a user choosing the real-time mode of operation (by selecting the option 502 of FIG. 5), a dialog box 600 as shown in FIG. 6 is presented to a display by the profiler, which allows a user to input an archive file name (in the input box 601) and history limit (in the input box 602). The archive file name specifies the name of a trace file that the profiler creates and writes the real-time trace information to. In one embodiment, the archive file is written in “zip” format to conserve disk space. Archive files can later be opened as trace files and analyzed in post-mortem mode of the profiler. A browse button 603 can be used to browse existing files and directories before creating an archive file.

The history limit (input to the box 602) restricts how much trace information (or “raw performance data”) is written to the archive file. For example, given a history limit X, only the X most recent cycles of trace information are saved in the archive file.

After the user specifies the archive file name and history limit, the user may click on the Connect button 604 to ready the profiler for operation in real-time mode. The user may then initiate execution of a software image (e.g., the software image 202 of FIG. 2) on a target hardware platform (e.g., the target hardware platform 201 of FIG. 2) on a testing platform, and the profiler receives generated raw performance data in substantially real-time, as generated by the testing platform during execution of the software image on the target hardware platform. For instance, in the exemplary embodiment of FIG. 4, a user may execute a software image on the QDBX simulator 401 with the following commands:

1. load—this command triggers QDBX to read the executable file containing the DSP firmware instructions along with related data;

2. trace log socket—this command informs QDBX that it should send logging/profiling information over a socket (as opposed to a log file);

3. trace socket open—this command causes QDBX to “listen” for UDP socket connections; this is employed so that QDBX is ready for the dynamic profiler to connect to it;

4. trace execution on—this command triggers “streaming” of logging/profiling information from QDBX over the socket;

5. continue—QDBX continues execution of the instructions of the executable file.

The profiler then proceeds to display the trace information received from the testing platform (e.g., from the QDBX simulator 401) and generate a trace file containing trace information for the last X cycles, as defined in the box 602 of FIG. 6. When program execution is completed, in the exemplary embodiment of FIG. 4, the user may use the command trace socket close on the QDBX simulator 401 to close the socket connection between the simulator 401 and the profiler 403.

A user may choose to place the profiler into the constraint violation mode, by selecting the option 503 of FIG. 5. According to one embodiment, before using the profiler in constraint violation mode, a user first creates a text file that specifies the desired performance constraints. In certain embodiments, each constraint in the file is specified by the following text format:

Start: process: event

End: process: event

MaxCycles: limit

In the above, “process” specifies the kernel or process in which an event occurs. The kernel is specified with the literal value kernel, while processes are specified by their process name. “Event” specifies a kernel- or process-specific event. “Limit” specifies the maximum cycles allowed between the occurrences of the start and end events. The following is an illustrative example of one possible constraint violation file that may be employed:

Start: ADECTASK: Execute process

End: AENCTASK: Execute process

MaxCycles: 200000

Start: AFETASK: afe_cmd_ccfg

End: AFETASK: sys_start_timer

MaxCycles: 2000

In the above example, ADECTASK, AENCTASK and AFETASK are user-defined tasks in the executable file loaded into QDBX (using the “load” command). The first constraint specifies that there should be a maximum of 200000 cycles between when ADECTASK starts execution and when AENCTASK starts execution. The second constraint specifies that there should be a maximum of 2000 cycles between the start of execution of the function afe_cmd_ccfg and the start of execution of the function sys_start_timer in the AFETASK task.

In addition to a user manually-creating constraint files, the dynamic profiler may have certain pre-defined constraint files that are available for selection by the user.

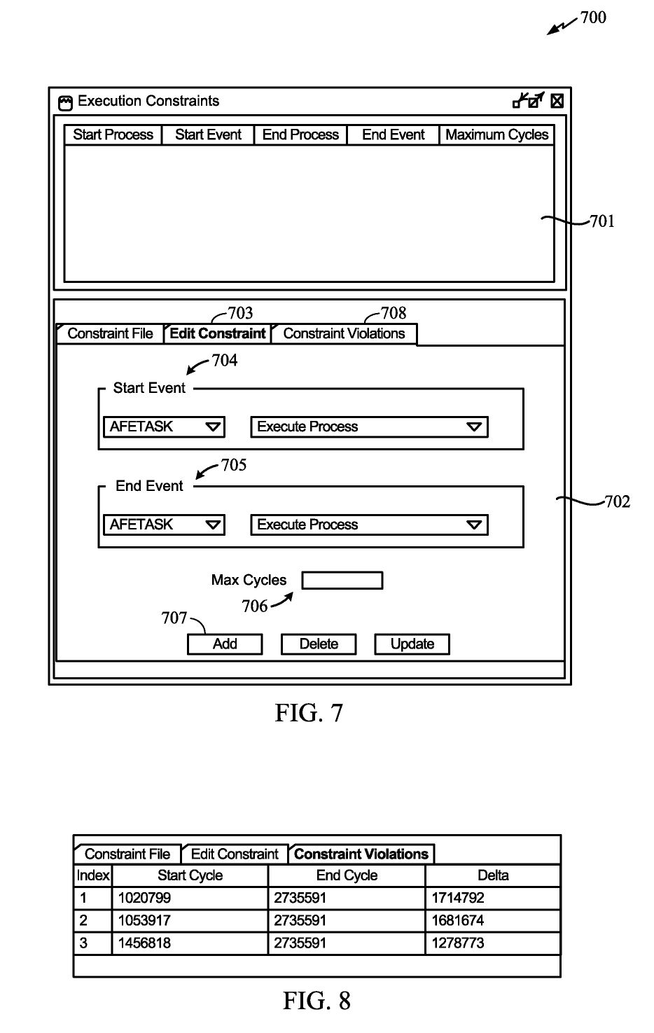

In certain embodiments, the profiler allows users to specify time limits between arbitrary system events and to list all violations of the limits. Time limits may be specified (and time limit violations listed) in a constraint window presented by the profiler to a display, such as the exemplary constraint window 700 of FIG. 7. In the exemplary constraint window 700, there is a top pane 701, which lists the current execution (or “performance”) constraints that are active for a running test/simulation. A bottom pane 702 can be used to perform the following tasks:

Edit individual execution constraints;

List the constraint violations for the selected constraint; and

Save or load the current constraints to a file.

In this example, execution constraints are specified in the Edit Constraint tab 703 of the constraint window 700. In this example, an execution constraint contains the following items:

a) Start event 704 and end event 705 (which can be any of the following): i) A call to a specific kernel function within the kernel; ii) A call to a specific kernel or process function within a specific process; or iii) When a specific process begins executing; and

b) Time limit 706 (maximum cycles allowed between the occurrence of the start and end events).

To create a new constraint, the user enters values for these items and clicks on the Add button 707. To modify an existing constraint, a user can select it in the top pane 701 of the constraint window 700 (none are listed in the example of FIG. 7), and then change one or more values presented (in the lower pane 702) for the selected constraint.

In one embodiment, the profiler automatically searches the trace file for any violations of the selected constraint. To view the constraint violations for a given constraint, a user can click on its entry in the top pane 701 of the constraint window 700 and then click on the Constraint Violations tab 708 in the bottom pane 702, which may present a listing of constraint violations such as that shown in FIG. 8. As shown in the example of FIG. 8, in certain embodiments, the following information is listed for each violation occurrence:

a) The starting and ending cycle of the violation; and

b) The number of cycles between the start and end events.

In one embodiment, selecting a violation in the bottom pane of the constraint window 700 causes the profiler to mark the position of the violation in the history window. For instance, a vertical line (which may be colored brown) may be drawn at the start cycle, and a vertical line (which may be colored red) may be drawn at the end cycle, in the graphical execution history window presented by the dynamic profiler.

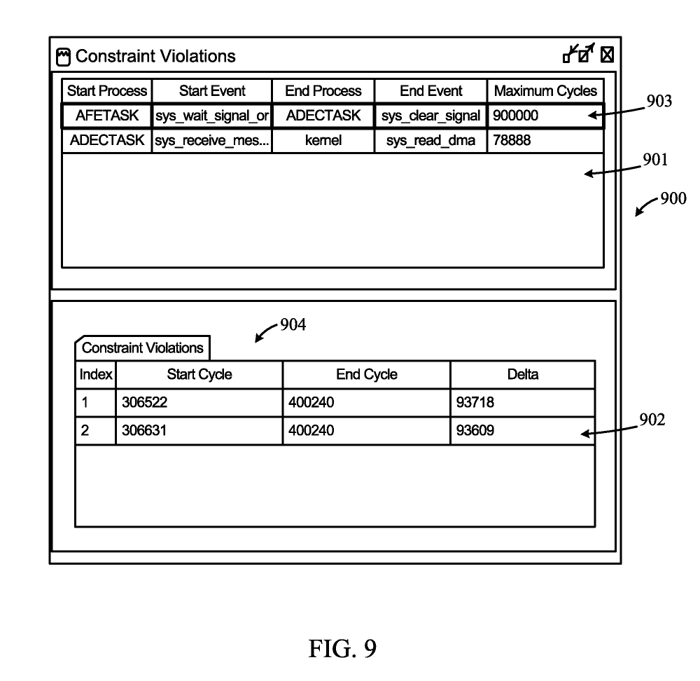

In one embodiment, the dynamic profiler allows a user to view the original performance constraints and constraint violations generated by the constraint violation mode in a constraint violation window, such as the exemplary constraint violation window 900 of FIG. 9. The constraint violation window 900 has an upper pane 901 and a bottom pane 902. The upper pane 901 lists performance constraints that are/were pre-defined for a given testing/simulation, and the bottom pane 902 shows the violations of a performance constraint selected in the upper pane 901. For instance, in the illustrated example of FIG. 9, a first performance constraint 903 is selected in the upper pane 901, and the corresponding violations 904 of that selected constraint that were detected during testing/simulation are shown in the bottom pane 902.

In accordance with certain embodiments, the dynamic profiler may present various profile and/or debug information to the user. For instance, various information pertaining to CPU utilization, cache utilization, etc. by the software-based image on the target hardware platform during the testing may be presented to the user. As one example, in certain embodiments, an execution history window can be presented by the dynamic profiler, as is conventionally presented by profilers, e.g., to display a graphical indication of which functions executed for how long, etc. Such execution history window may present data as it is received in substantially real-time, or the execution history window may be employed to display history data captured for a constraint violation, as examples. Of course, the execution history window may also be employed in a conventional post mortem mode when so desired. Various other information that may be presented are briefly described below.

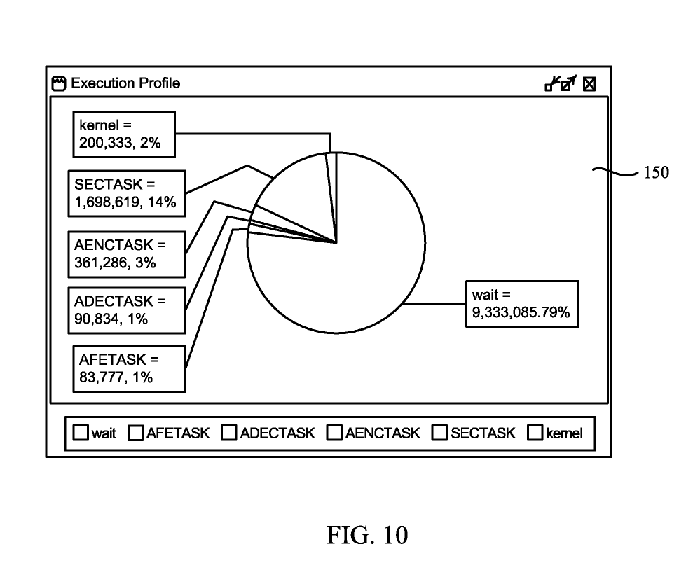

In one embodiment, the dynamic profiler is operable to display a pie chart of the CPU usage in a CPU usage profile window, such as shown in the exemplary CPU usage profile window 150 of FIG. 10. The CPU usage (or “execution”) profile window 150 shows the relative amounts of CPU usage by the kernel and processes, and labels each one with the number of cycles executed by the kernel or process and the corresponding percentage of CPU usage observed during the testing. In one embodiment, when a user moves a cursor over a segment of the pie chart, a popup note showing the number of cycles executed by the corresponding kernel or process may be generated and presented to the user.

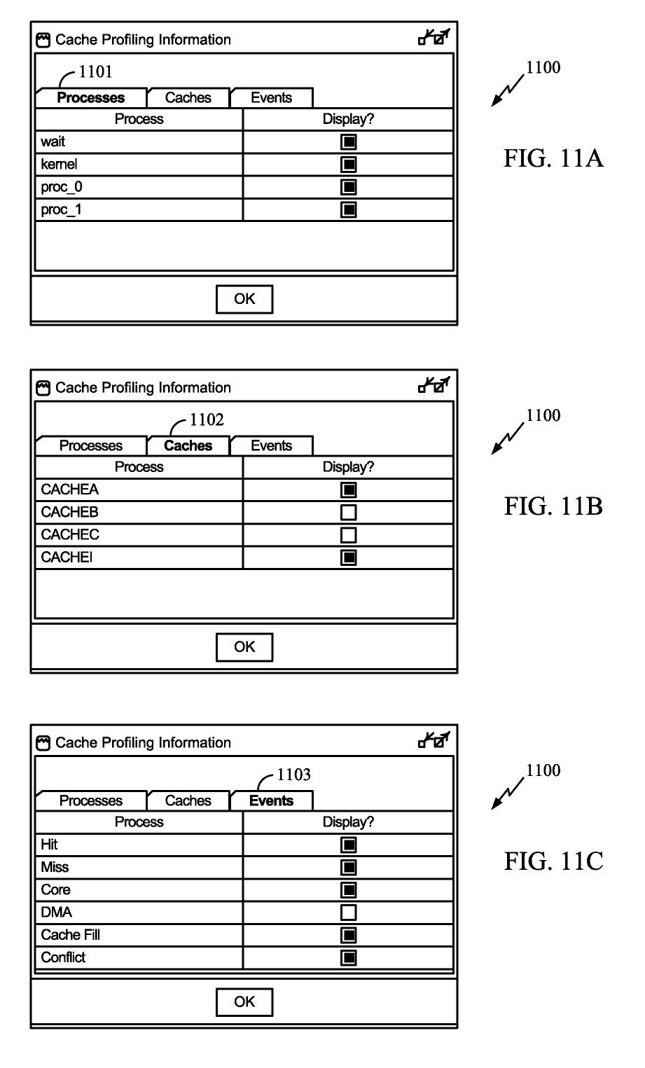

In one embodiment, a user can limit the display of cache event information to specific processes, caches, or event types, such in the exemplary cache profiling information window 1100 shown in FIGS. 11A-11C. To bring up the cache profiling information window 1100 in one embodiment, the user can select “Cache Profiling Information” from a “View menu” option presented by the user interface of the dynamic profiler.

The processes tab 1101 is shown as selected in FIG. 11A, which enables a user to select one or more of the various processes for which their respective cache usage/event information is to be presented. Clearing a checkbox hides the cache events for the corresponding process; setting a checkbox displays the processes' cache events.

Similarly, a user can choose to filter events by cache, using the caches tab 1102, such as shown in FIG. 11B. Thus, when the caches tab 1102 is selected, the user can select one or more of the various caches for which their respective usage/event information is to be presented.

Similarly, a user can choose to filter for specific event types by selecting the events tab 1103, such as shown in FIG. 11C. Thus, when the events tab 1103 is selected, the user can select one or more of the various event types for which their respective cache usage/event information is to be presented.

In either case, after the user clicks the OK button, all cache profiling windows presented by the dynamic profiler may update to show only the information specified.

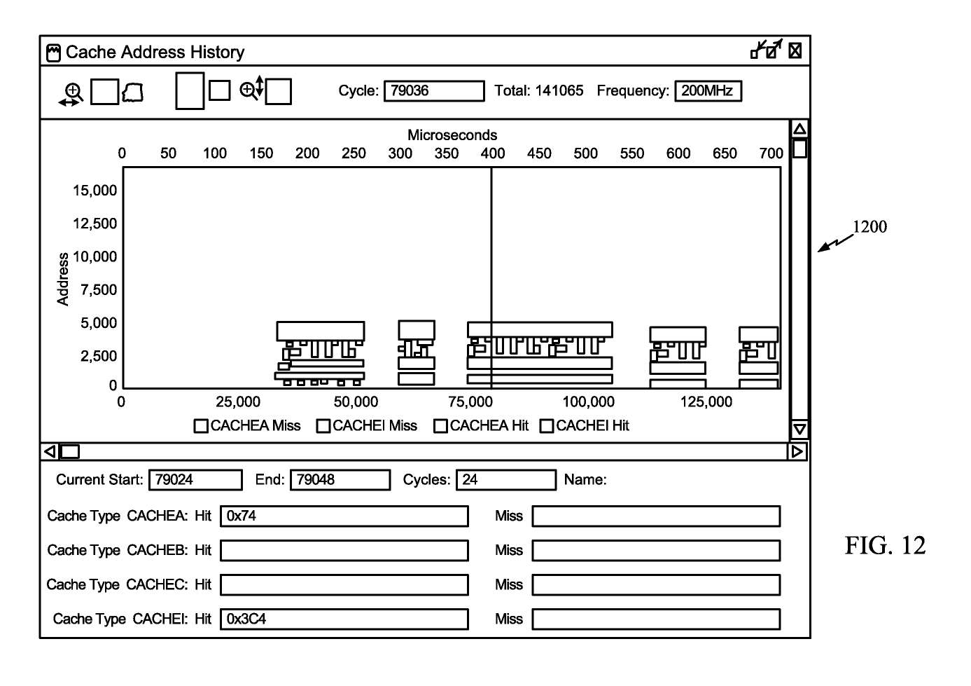

In one embodiment, the dynamic profiler is operable to display the cache memory address events across time in a cache address history window, such as the exemplary cache address history window 1200 shown in FIG. 12. Cache address information is used to determine if certain memory locations are not being efficiently accessed through the cache. Displayed cache events may be color-coded by event type. The hex values in the cache type lines indicate the address where the cache hit or miss occurred. By clicking on the graphical information presented, in certain embodiments the user is allowed to zoom in to receive a more detailed view of a selected portion of the information.

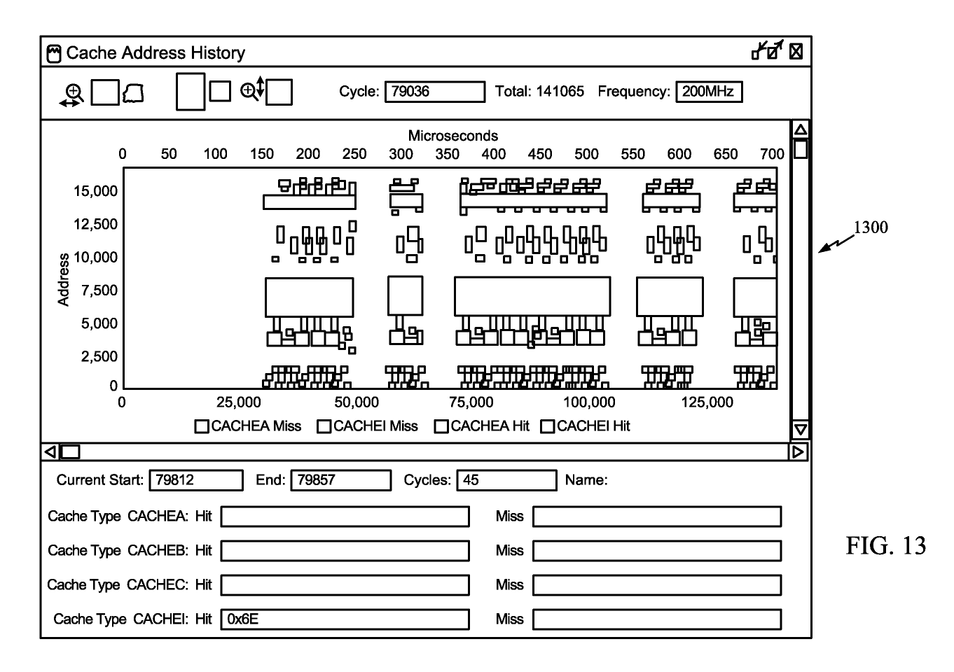

In one embodiment, the dynamic profiler is operable to display the cache line events across time in a cache line history window, such as the exemplary cache line history window 1300 shown in FIG. 13. Cache line history is used to determine how efficiently the cache is being used. Displayed cache events may be color-coded by event type. The hex values in the cache type lines indicate the line where the cache hit or miss occurred. By clicking on the graphical information presented, in certain embodiments the user is allowed to zoom in to receive a more detailed view of a selected portion of the information.

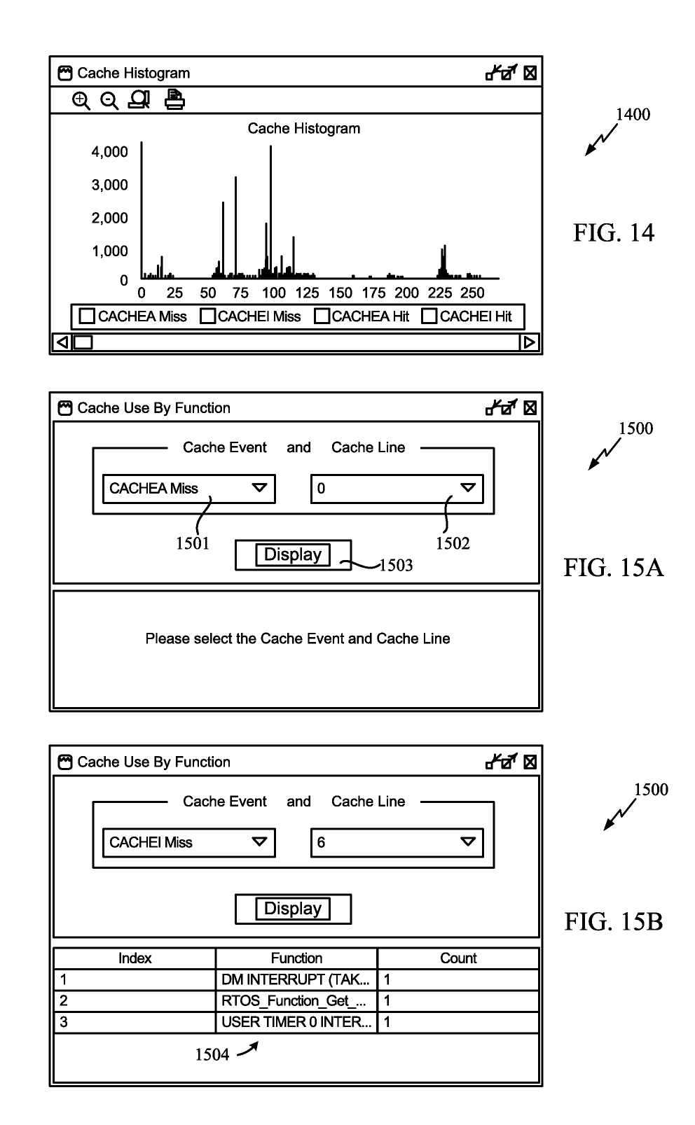

In one embodiment, the dynamic profiler is operable to display a histogram of cache line events in a cache histogram window, such as the exemplary cache histogram window 1400 shown in FIG. 14. The horizontal axis in this example indicates the cache line number, and the vertical axis indicates the number of cache events in a particular cache line.

In one embodiment, the dynamic profiler is operable to display cache event counts by function in a cache use by function window, such as the exemplary cache use by function window 1500 shown in FIG. 15A. The user can select an event type from the Cache Event pull-down menu 1501 and may select the cache line from the Cache Line pull-down menu 1502. By selecting the display button 1503, information detailing the observed cache usage by the selected function, as defined in window 1500, is presented by the dynamic profiler. For instance, in this example, responsive to a user selecting the display button 1503, the lower pane of the window displays the number of cache hits and misses in each function that uses the cache line, such as shown in the exemplary output 1504 of FIG. 15B. In certain embodiments, if the user selects a line in the window pane, the dynamic profiler's history window highlights all the occurrences of the cache event with a vertical black bar.

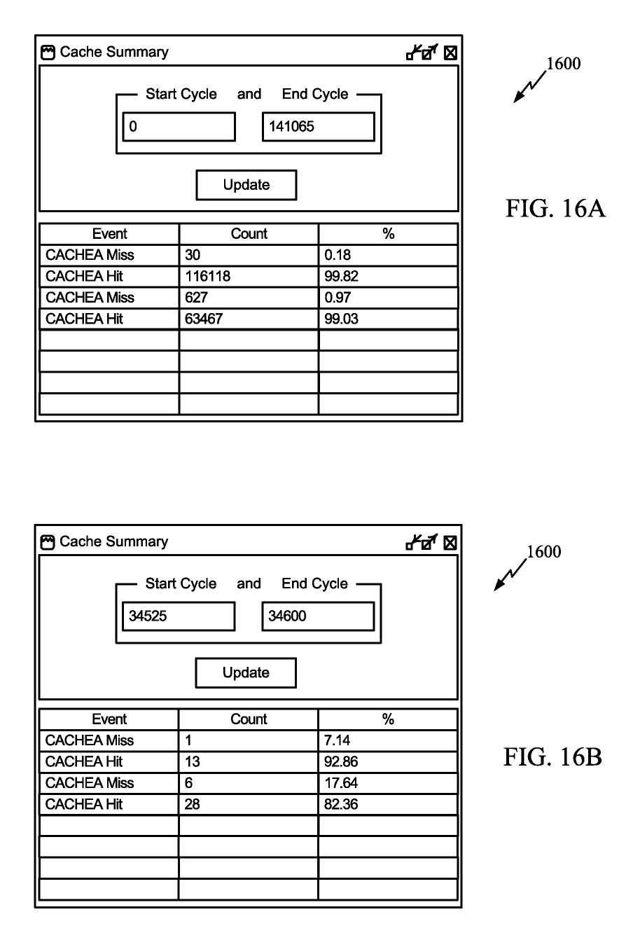

In one embodiment, the dynamic profiler is operable to display cache event counts over a given cycle range in a cache summary window, such as the exemplary cache summary window 1600 shown in FIG. 16A. Another example of such cache summary window 1600 is shown in FIG. 16B (with a different clock cycle range selected than in FIG. 16A). In the examples of FIGS. 16A-16B, the user can set the start and end cycles for the range the user wants to examine. The lower pane of the window 1600 displays the cache event's percentages of hits versus misses (or misses versus hits) within the cycle range.

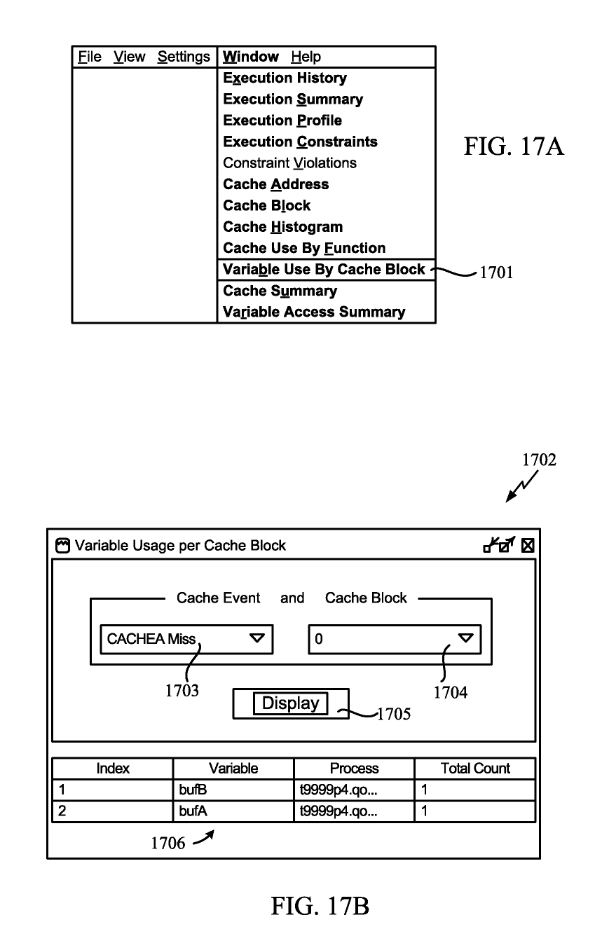

Certain embodiments enable an analysis of variable use by cache block. That is, cache use of individual variables by the software-based image under test can be analyzed. FIGS. 17A-17B show one exemplary user interface of the dynamic profiler for such variable use by cache block. In this embodiment, the Variable Use by Cache Block item 1701 (of the user interface window of FIG. 17A) may be selected to cause the dynamic profiler to display the total access of variable per cache block. Then, the user is presented with the exemplary window 1702 of FIG. 17B, in which the user may choose the cache event (via drop down menu 1703) and cache block (via drop down menu 1704), and then click the display button 1705 to display all variables access details, such as shown in the exemplary output 1706 in the lower pane of the window of FIG. 17B.

Presentation of information by a profiler may be performed, in certain embodiments, irrespective of whether the dynamic profiler is operating in post mortem mode or in real-time or constraint violation modes.

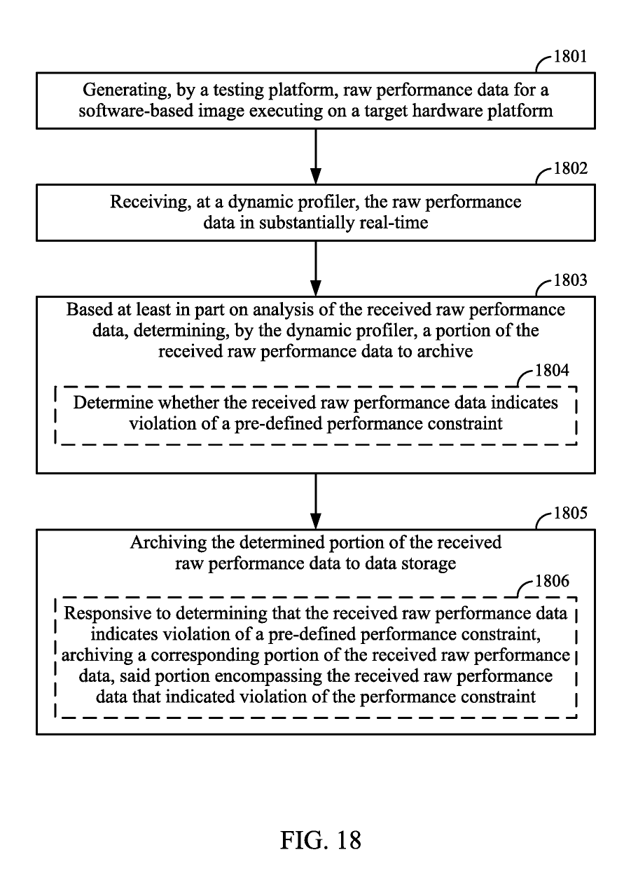

FIG. 18 shows an operational flow diagram according to one embodiment. In block 1801, a testing platform (e.g., the testing platform 210 of FIGS. 2-3) generates raw performance data for a software-based image (e.g., the software image 202 of FIGS. 2-3) executing on a target hardware platform (e.g., the target hardware platform 201 of FIGS. 2-3). In block 1802, a dynamic profiler (e.g., the dynamic profiler 220 of FIGS. 2-3) receives the raw performance data in substantially real-time, as it is generated by the testing platform (e.g., during an ongoing test execution of the software-based image on the target hardware platform).

In block 1803, the dynamic profiler determines, based at least in part on analysis of the received raw performance data, a portion of the received raw performance data to archives For instance, in certain embodiments, as indicated in the optional dashed block 1804, the dynamic profiler determines whether the received raw performance data indicates a violation of a pre-defined performance constraint.

In block 1805, the determined portion of the received raw performance data is archived to data storage (e.g., to hard disk, magnetic disk, optical disk, or other suitable digital data storage device). In certain embodiments, as indicated in the optional dashed block 1806, responsive to determining that the received raw performance data indicates violation of a pre-defined performance constraint, a corresponding portion of the received raw performance is archived. The portion encompasses the received raw performance data that indicated violation of the performance constraint. As discussed above, in certain embodiments a user defines an amount of performance data that is to be archived for a detected performance constraint violation (e.g., in the input box 706 of FIG. 7).

Embodiments of a dynamic profiler as described above, or portions thereof, may be embodied in program or code segments operable upon a processor-based system (e.g., computer system) for performing functions and operations as described herein. The program or code segments making up the various embodiments may be stored in a computer-readable medium, which may comprise any suitable medium for temporarily or permanently storing such code. Examples of the computer-readable medium include such physical computer-readable media as an electronic memory circuit, a semiconductor memory device, random access memory (RAM), read only memory (ROM), erasable ROM (EROM), flash memory, a magnetic storage device (e.g., floppy diskette), optical storage device (e.g., compact disk (CD), digital versatile disk (DVD), etc.), a hard disk, and the like.

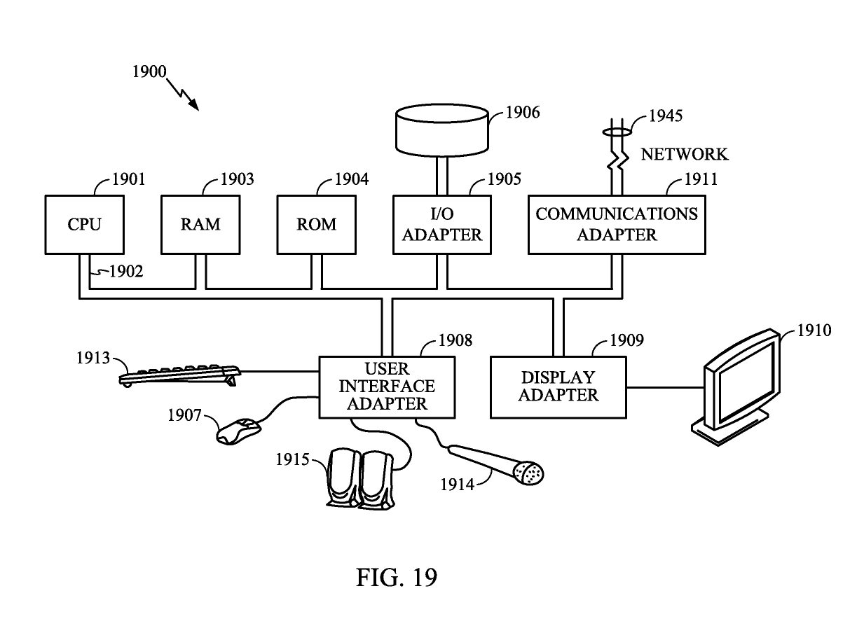

FIG. 19 illustrates an exemplary computer system 1900 on which embodiments of a dynamic profiler may be implemented. A central processing unit (CPU) 1901 is coupled to a system bus 1902. The CPU 1901 may be any general-purpose CPU. The dynamic profiler is not restricted by the architecture of the CPU 1901 (or other components of the exemplary system 1900) as long as the CPU 1901 (and other components of the system 1900) supports the operations as described herein. The CPU 1901 may execute the various logical instructions according to embodiments. For example, the CPU 1901 may execute machine-level instructions for performing processing according to the exemplary operational flows of a dynamic profiler as described above in conjunction with FIGS. 2-3 and 18.

The computer system 1900 also preferably includes random access memory (RAM) 1903, which may be SRAM, DRAM, SDRAM, or the like. The computer system 1900 preferably includes read-only memory (ROM) 1904 which may be PROM, EPROM, EEPROM, or the like. RAM 1903 and ROM 1904 hold user and system data and programs, as is well known in the art.

The computer system 1900 also preferably includes an input/output (I/O) adapter 1905, a communications adapter 1911, a user interface adapter 1908, and a display adapter 1909. The I/O adapter 1905, the user interface adapter 1908, and/or the communications adapter 1911 may, in certain embodiments, enable a user to interact with the computer system 1900 in order to input information to the dynamic profiler, such as inputs discussed with the above-described exemplary user interface windows.

The I/O adapter 1905 preferably connects to the storage device(s) 1906, such as one or more of hard drive, compact disc (CD) drive, floppy disk drive, tape drive, etc. to the computer system 1900. The storage devices may be utilized when the RAM 1903 is insufficient for the memory requirements associated with storing data for operations of the dynamic profiler. The data storage of the computer system 1900 may be used for archiving at least portions of received raw performance data by the dynamic profiler, as discussed above (e.g., as the storage 205 in FIGS. 2-3). The communications adapter 1911 is preferably adapted to couple the computer system 1900 to a network 1912, which may enable information to be input to and/or output from the system 700 via such network 1912 (e.g., the Internet or other wide-area network, a local-area network, a public or private switched telephony network, a wireless network, any combination of the foregoing). The user interface adapter 1908 couples user input devices, such as a keyboard 1913, a pointing device 1907, and a microphone 1914 and/or output devices, such as speaker(s) 1915 to the computer system 1900. A display adapter 1909 is driven by the CPU 1901 to control the display on the display device 1910 to, for example, display output information from the dynamic profiler, such as the exemplary output windows discussed above.

It shall be appreciated that the dynamic profiler is not limited to the architecture of the system 1900. For example, any suitable processor-based device may be utilized for implementing all or a portion of embodiments of the dynamic profiler, including without limitation personal computers, laptop computers, computer workstations, and multi-processor servers. Moreover, embodiments of the dynamic profiler may be implemented on application specific integrated circuits (ASICs) or very large scale integrated (VLSI) circuits. In fact, persons of ordinary skill in the art may utilize any number of suitable structures capable of executing logical operations according to the embodiments of the dynamic profiler.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for performing system profiling of an entity executing on a testing platform, the method comprising:
receiving, by a profiler, performance constraint data, the performance constraint data defining boundary conditions for an event;
receiving, in substantially real-time at the profiler, raw performance data from a testing platform about the execution entity to be profiled;
analyzing, by the profiler, the received raw performance data to determine when the execution entity violates a performance constraint defined by the performance constraint data; and
storing only a portion of the received raw performance data, wherein the portion corresponds to a time period of execution of the execution entity that overlaps when a determined performance constraint violation occurred.

2. The method of claim 1 wherein the execution entity comprises a software-based image executing on a target hardware platform.

3. The method of claim 2 wherein the target hardware platform comprises a digital signal processor.

4. The method of claim 2 wherein the target hardware platform comprises a simulation of a target hardware platform.

5. The method of claim 1 wherein the receiving, in substantially real-time, comprises:
receiving the raw performance data from the testing platform as the raw performance data is generated by the testing platform during execution of the execution entity on the testing platform.

6. The method of claim 1 wherein a length of the time period is user-defined.

7. The method of claim 1 further comprising:
generating, by the profiler, a graphical output of at least the portion of the received raw performance data.

8. The method of claim 1 further comprising:
debugging said execution entity by the profiler based at least in part on the received raw performance data.

9. The method of claim 1 further comprising:
determining, by the profiler, based on the received raw performance data, at least one of cache use by function and variable use by cache block; and
presenting, by the profiler, a user interface displaying at least one of the determined cache use by function and the determined variable use by cache block.

10. A system for profiling performance of a software-based image on a target hardware platform, the system comprising:
a testing platform for generating raw performance data for the software-based image executing on the target hardware platform;
a dynamic profiler communicatively coupled to the testing platform for receiving the raw performance data in substantially real-time as it is generated by the testing platform, the dynamic profiler operable to determine, based at least in part on analysis of the received raw performance data, a portion of the received raw performance data to archive, thereby resulting in a determined portion of the received raw performance data; and
data storage for archiving the determined portion of the received raw performance data.

11. The system of claim 10 wherein the dynamic profiler is operable to determine whether the received raw performance data indicates violation of a pre-defined performance constraint by the software-based image executing on the target hardware platform.

12. The system of claim 11 wherein, responsive to determining that the received raw performance data indicates violation of the pre-defined performance constraint, the dynamic profiler is operable to archive a corresponding portion of the received raw performance data, the portion encompassing the received raw performance data that indicated violation of the pre-defined performance constraint.

13. The system of claim 11 wherein the dynamic profiler comprises:
a user interface for receiving input specifying the pre-defined performance constraint.

14. The system of claim 13 wherein the dynamic profiler comprises:
a user interface for receiving input specifying an amount of raw performance data to archive responsive to detection of the pre-defined performance constraint.

15. The system of claim 10 wherein the target hardware platform comprises a digital signal processor.

16. The system of claim 15 wherein the software-based image comprises firmware for the digital signal processor.

17. The system of claim 10 wherein the target hardware platform comprises a simulation of a target hardware platform.

18. The system of claim 10 wherein the dynamic profiler comprises computer-executable software code stored to a computer-readable medium that when executed by a processor causes the processor to perform at least the receiving the raw performance data in substantially real-time.

19. A computer program product, comprising:
a computer-readable medium comprising:
code for causing a computer to receive raw performance data in substantially real-time when generated by a testing platform on which a software-based image is executing on a target hardware platform;
code for causing the computer to determine whether the received raw performance data indicates violation of a pre-defined performance constraint; and
code for causing the computer to, responsive to determining that the received raw performance data indicates violation of a pre-defined performance constraint, archive a corresponding portion of the received raw performance data, wherein the corresponding portion encompasses the received raw performance data that indicated violation of the performance constraint.

20. The computer program product of claim 19 wherein the target hardware platform comprises a digital signal processor.

21. The computer program product of claim 19 wherein the target hardware platform comprises a simulation of a target hardware platform.

22. The computer program product of claim 19 wherein the computer-readable medium further comprises:
code for causing the computer to receive, via a user interface, input specifying the pre-defined performance constraint.
